(19) United States
(12) Patent Application Publication
(10) Pub. No.: US 2002/0175642 A1
(43) Pub. Date: Nov. 28, 2002

(54) Industrial lighting control system

(76) Inventors: Michael C. von Kannewurff, Middlebury, CT (US); Christopher Scott Fuselier, Farmington, CT (US); Bo Lundager Andersen, Burlington, CT (US)

Correspondence Address: CANTOR COLBURN, LLP, 55 GRIFFIN ROAD SOUTH, BLOOMFIELD, CT, 06002

(21) Appl. No.: 09/683,877

(22) Filed: Feb. 26, 2002

Related U.S. Application Data
(63) Continuation-in-part of application No. 09/681,704, filed on May 23, 2001.

(51) Int. Cl. H05B 37/00

(52) U.S. Cl. 315/312; 315/317

(57) ABSTRACT

A lighting control system including: a first control unit for operating a first light fixture, the first control unit arranged to receive a signal from an input device, the first control unit arranged to control the input device; and a second control unit for operating a second light fixture, the second control unit in operable communication with the first control unit.

### CROSS REFERENCE TO RELATED APPLICATIONS

This application is a continuation-in-part of U.S. application Ser. No. 09/681,704, filed May 23, 2001, which is incorporated herein in its entirety.

### BACKGROUND OF INVENTION

Industrial lighting systems possess several electro-mechanical problems. Because most light fixtures draw an increased amount of current while warming up, the main contactor experiences large current surges at the instant of closure. Moreover, high in-rush currents and the like can reduce their expected service life by eroding the contact surfaces.

Additional problems stem from the centralized wiring systems currently employed. To provide the necessary current to operate heavy industrial loads such as in lighting auditoriums, stadiums, factories, etc. heavy wiring must be routed through a central location where the lighting contactors are installed. In such situations, lighting contactors are prone to produce an unpleasant and disruptive electrical hum and/or vibration caused by the high concentration of current. Furthermore, in these highly centralized systems, if a contactor fails, all of the lights that it controls will be rendered inoperative.

Furthermore, conventional industrial lighting systems have not adequately met the needs of their users. The existing systems do not allow the user to dim a section of the buildings lights. In addition, conventional industrial lighting systems have no means of collecting and displaying wear data on the system, so that maintenance personnel can anticipate problems, such as a contactor failure or wearout, lamp failure or wearout, or other problem before it occurs. There is also no system in place to remotely detect lamp failures.

For the past decade a number of companies have marketed residential lighting control systems comprised of wall switches, wall outlets, and various other devices equipped with electronics. These products have enabled a residential or low-end commercial user to remotely switch multiple lamps and other loads via a control panel. Traditionally, the communication technology for this type of application has been through hard-wired networks, RF communications and power line based communications.

However, conventional residential lighting systems have not addressed the issues discussed above with respect to industrial lighting. In particular, conventional residential lighting systems do not provide a means to monitor the usage for lamps and other loads. Furthermore, conventional residential lighting systems are not designed to alert the user of lamp failures, nor do they address the problems of rapid surges and sudden voltage drops that can occur when a large lighting system is energized.

### SUMMARY OF INVENTION

The above discussed and other drawbacks and deficiencies are overcome and alleviated by a lighting control system. In an exemplary embodiment, the lighting control system includes: a first control unit for operating a first light fixture, the first control unit arranged to receive a signal from an input device, the first control unit arranged to control the input device; and a second control unit for operating a second light fixture, the second control unit in operable communication with the first control unit.

### BRIEF DESCRIPTION OF DRAWINGS

Referring to the exemplary drawings wherein like elements are numbered alike in the several Figures:

FIG. 1 is schematic diagram of a multiple integrated light control system using light fixture modules;

FIG. 2 is a schematic drawing of the multiple integrated light control system of FIG. 1 attached to a computer system.

FIG. 3 is a module attached to a light fixture; and

FIG. 4 is a combined light fixture module.

### DETAILED DESCRIPTION

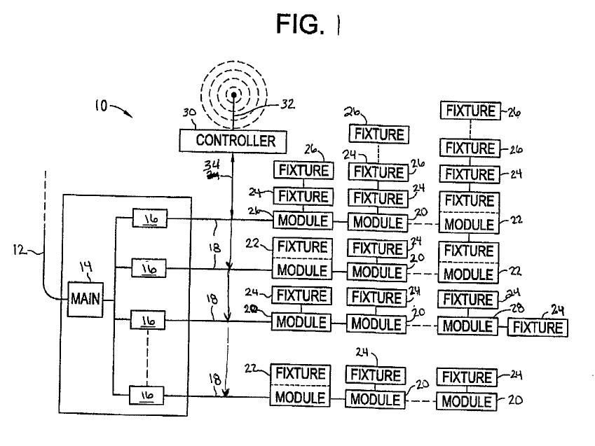

FIG. 1 illustrates a schematic diagram of a lighting control system 10. A main power line 12, which may be a conventional 3-wire 220V AC power line, feeds into a main contactor 14 and one or more branch circuit breakers 16, each controlling a branch circuit 18, as is well known. For simplicity, FIG. 1 does not show the separate phases, ground, and neutral lines.

Main power line 12 provides power through each branch circuit 18 to one or more modules 20, module-fixtures 22, or combinations thereof. Modules 20 control power to associated fixtures 24. Other electric loads, such as ventilation fans, air conditioners, heaters, other environmental equipment, or other equipment in general can be connected to modules 20 as well. Preferably, fixtures 24 and module-fixtures 22 operate on 110V AC power. However, it should be understood that the invention is equally applicable to systems using different voltages.

Module-fixtures 22 can be used interchangeably with modules 20 each having fixture 24 attached to it. Also, modules 20 and module-fixtures 22 can control fixture 24 and any number of additional, auxiliary fixtures 26 by connecting auxiliary fixtures 26 in parallel with fixture 24. For each module 20, fixture 24 and auxiliary fixtures 26 are turned on or off or are dimmed together. Likewise, module-fixture 22 and auxiliary fixtures 26 connected to module-fixture 22 are also turned on or off or are dimmed together. It is also possible to provide module 20 or module-fixture 22 with multiple independently-controlled outputs as in multi-module 28, which is shown as having two fixtures connected to separate outputs thereof in FIG. 1. The dashed lines in FIG. 1 represent that any selected number of branch circuits form the lighting system, any number of modules can be positioned on each branch circuit, depending, of course, on the current limitations of the circuit, and any number of fixtures can be connected to and controlled by each module, again, depending on the current limitations of the circuit.

Modules 20 and module-fixtures 22 are in communication with a controller 30. Communication is achieved by radio, e.g., via antenna 32, or by signal connection 34 to branch circuits 18. In the latter case, communication is achieved by transmitting high-frequency signals through branch circuits 18 in the well-known manner. For example, the communications may be made over ordinary power lines using the CEBus™ protocol standard that is promulgated by the Electronics Industries Association. In addition to these preferred methods, communication may be established over other known mediums including twisted pair (telephone), coaxial cable, fiber optics, and infrared. As is known, these methods may be augmented by interfacing computer networks, such as a campus-wide, wide-area network or even using an Internet interface. So, while the system is shown in FIG. 1 as being powered through a single main circuit breaker, there is no such limitation in actual practice. Using known electronic communication techniques, controller 30 is capable of controlling any number of modules positioned anywhere, whether on a single main power distribution circuit or not.

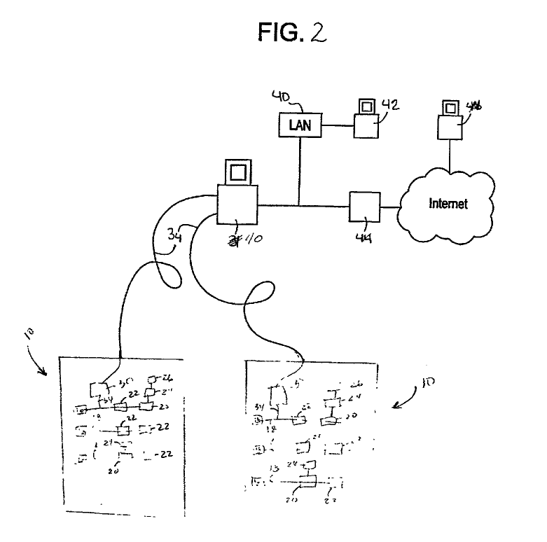

Referring to FIG. 2, controller 30 may be a dedicated wall-mounted switch, control console, or a general-purpose personal computer. Controller 30 is a suitable electronic device capable of accepting data and instructions, executing the instructions to process the data, and presenting the results. Therefore, controller 30 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer, a scientific calculator, or a hybrid of any of the foregoing.

Signal connection 34 includes, but is not limited to, twisted pair wiring, coaxial cable, and fiber optic cable. Signal connection 34 also includes, but is not limited to, radio and infrared signal transmission systems. Controller 30 is configured to provide operating signals to modules 20 and module-fixtures 22 and to receive data from these components via signal connection 34.

Lighting control system 10 may connect to a building supervisory system 40. Building supervisory system 40 monitors, configures, and activates modules 20, module-fixtures 22, fixtures 24, auxiliary fixtures 26, and multi-modules 28. Building supervisory system 40 is not necessary to operate lighting control system 10; however, supervisory system 40 provides an addition manner in which to control lighting control system 10. Building supervisory system 40 may also monitor, configure, and activate heating and cooling systems, security systems, fire alarm system, and any other building automation systems.

Controller 30 may also be coupled to external computer networks such as a local area network (LAN) 42 and the Internet. LAN 42 interconnects one or more remote computers 44, which are configured to communicate with controller 30 using a well-known computer communications protocol such as TCP/IP (Transmission Control Protocol/Internet Protocol), RS-232, ModBus, and the like. Additional lighting control systems 10 may also be connected to LAN 42 with controller 30 in each of these lighting control systems 10 being configured to send and receive data to and from remote computers 44 and other lighting control systems 10. LAN 42 may be connected to the Internet via a server computer 46. This connection allows controller 30 to communicate with one or more remote computers 44 connected to the Internet. The computer network allows an operator located either locally or remotely to send and receive data to controllers 30 located throughout a building.

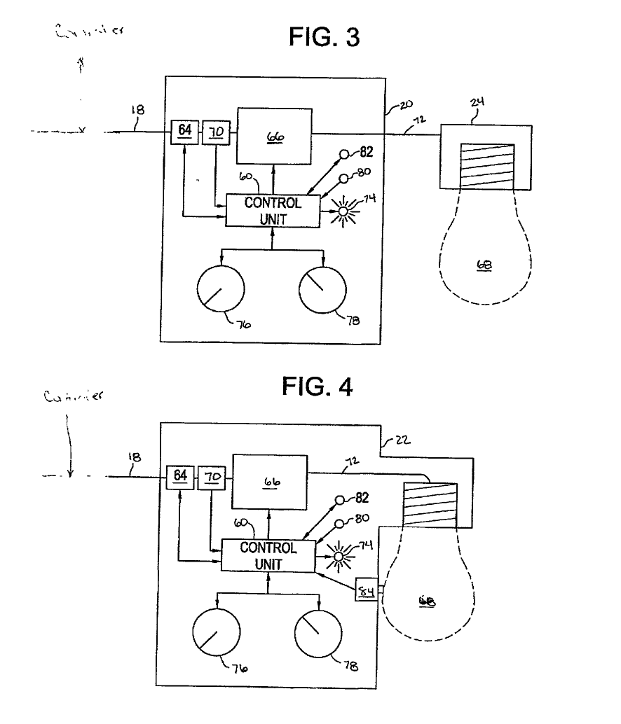

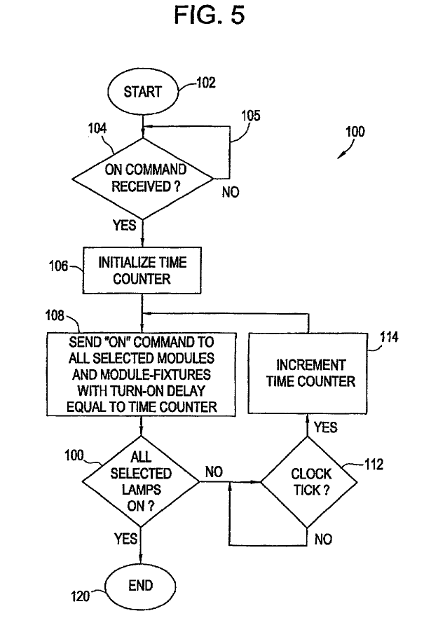

Referring to FIGS. 3 and 4, a schematic diagram of module 20 and module-fixture 22 are illustrated, respectively. Each module 20 and module-fixture 22 includes a control unit 60 that receives inputs and signals from a plurality of input devices and also controls the plurality of input devices. The input devices may include a signal processor 64, a current controller 66, and a current and power supply 70. In addition, each control unit 60 communicates with the other control units 60 in lighting control system 10 so that each control unit 60 knows the status of the other control units 60. Control unit 60 may also be in communication with controller 30.

Control unit 60 communicates with each input device. For example, signal processor 64, which is in communication with control unit 60, sends and receives signals sent through branch circuits 18 in the known manner. Control unit 60 is connected to current controller 66, which may be a relay mechanism or dimmer such as are known. Current controller 66 controls the current to a lamp 68, which is either connected to a separate fixture 24 shown in FIG. 3 or is connected directly into module-fixture 22 as shown in FIG. 4. Lamp 68 may be any type of commercially available light source, such as an incandescent lamp, mercury-vapor lamp, fluorescent lamp, or other discharge device. Any required additional electronic components required for lamp 68 such as ballasts or other current-regulating means are omitted from the drawings, as they do not form a part of the invention. For the embodiment shown in FIG. 3, such components would be connected between current controller 66 and lamp 68 either in a separate housing or located within or attached to fixture 24 as is known, or within module 20.

Current sensor and power supply 70 detects the current in a line 72 leading to lamp 68 and provides electrical power to control unit 60 and other associated components in a known manner even when no power flows through line 72. In an alternative embodiment, current sensor and power supply 70 is a current transformer that senses current in line 72 and provides electricity to control unit 60 only when current is flowing in line 72. In this case, control unit 60 includes a battery or other electricity storage device (not shown) to provide electricity even when lamp 68 is off.

Current sensor and power supply 70 can detect whether lamp 68 fails to generate a load when ordered to turn on and thus is defective or has died. In that case, an electronic message is sent out to controller 30 indicating a lamp failure and a visible indicator 74 is turned on. Indicator 74 may take the form of a light emitting diode, a mechanical flag, or equivalent. Indicator 74 remains on even after the lamps are turned off, e.g., when parking lot lamps are turned off during the day, to thereby alert maintenance personnel of the defective lamp.

In addition, each control unit 60 may receive inputs and signals from other input devices and also controls and communicates with other input devices. Module 20 and module-fixture 22 contain a timer 76 with a range from, e.g., 0 to 10, or 0 to 100 thousands of operating hours. Timer 76 may count down from a number of hours before lamp 68 is due to be replaced, or count up from the time lamp 68 was replaced to an expected number of hours of operation of lamp 68. Timer 76 may, for example, be a turn-wheel. In this case, the electrician installing lamp 68 will reset timer 76 to indicate the number of hours of operation before the next replacement is scheduled, e.g., the expected life of lamp 68, if timer 76 is a count-down timer. If timer 76 is a count-up timer, then the maintenance person will reset timer 76 to zero and ensure that an alarm setting is set to the number of hours of operation before the next replacement is scheduled.

When the lamp is turned on, control unit 60 operates timer 76 to slowly rotate the turn-wheel towards zero, if timer 76 is a count-down timer, or slowly rotate the turn-wheel away from zero, if the timer 76 is a count-up timer. In this way, timer 76 operates to indicate the remaining hours-of-operation of the connected lamp 68 before replacement is due. When timer 76 reaches zero or the selected alarm value, indicator 74 will illuminate, indicating that the replacement is due for lamp 68.

The function of timer 76 may be implemented either completely electronically, or electro-mechanically, as would be appreciated by a skilled artisan. It is also contemplated that timer 76, while preferably implemented as a turn-wheel as shown in FIGS. 3 and 4 due to its simplicity of operation, may be replaced with a digital interface, with the timing and indicating function performed by software within control unit 60 and a digital display (not shown).

Module 20 and module-fixture 22 also include a turn-on delay timer 78. The turn-on delay timer 78 includes settings from instantaneous to several seconds. For some lamp types having long warm-up times, the possible settings may be even greater. Turn-on delay timer 78 may also include a random setting, which allows control unit 60 to select a random turn-on delay. Selecting a variety of turn-on delays for all the fixtures in a lighting system will eliminate the current surge/voltage drop caused by a large number of lamps being turned on simultaneously.

In some outdoor installations, module 20 and module-fixture 22 may include a photo-sensor 80 to detect ambient light conditions. In this case, when control unit 60 receives an “on when dark” command, it will control current controller 66 to turn on lamp 68 only when there is insufficient ambient light available. For example, when the ambient light level drops to a first threshold, control unit 60 will turn on lamp 68, and when the ambient light reaches a second threshold higher then the first threshold, the control unit 60 will turn off lamp 68. Although not required, the use of two thresholds reduces flickering.

Alternatively, only one or several of modules 20 or module-fixtures 22 include a photo-sensor 80, and control unit 60 thereof is periodically queried by controller 30 as to the current level of ambient light. Upon receiving this query, control unit 60 responds by sending a signal to controller 30 indicating the current ambient light level. When the ambient light reaches a user-selected lower threshold, controller 30 sends a signal to all modules 20 and/or module-fixtures 22 to turn on lamps 68. Querying several modules 20 and/or module-fixtures 22 will provide redundancy in case one of the photo-sensors malfunctions or becomes covered with debris.

An infrared (IR) transceiver 82 may be provided in each module 20 and module-fixture 22 for allowing communication between control unit 60 within the modules 20 and module-fixtures 22 and a hand-held controller device (not shown). There are many potential uses for IR transceiver 82. For example, a single hand-held controller may replace timer 76 and separate turn-on delay timer 78 in each module 20 or module-fixture 22, and all the functions are handled instead through the hand-held control device, which may be a hand-held computer such as a dedicated device or a Palm Pilot™, WindowsCE™ device, or equivalent, equipped with a standard IR interface and software allowing it to interact with control unit 60. Thus, by simply pointing the hand-held device to a light fixture, communication can be thereby established, and information as to the maintenance can be downloaded to the hand-held device, and instructions can be transmitted to control unit 60, including ON or OFF commands, as well as setting the turn-on delay and hours-of-operation of lamp 68. IR transceiver 82 may be disposed in a separate housing (not shown) and mounted adjacent to fixture 24 or module-fixture 22 in situations where a reflector (not shown) of the light fixture would otherwise block a line-of-sight to IR transceiver 82. This could be a solution in warehouse and factory lighting applications where large reflectors are sometimes employed.

IR transceiver 82 can also be used as a means of communicating with controller 30, which may be useful if the module or module-fixture is connected to a completely different circuit and thus cannot communicate via branch circuit 18.

The above description relates to a distributed model of monitoring lamp life and controlling turn-on delay. In an exemplary embodiment employing a centralized model, the functions described above are performed by controller 30 in a central or remote location as previously described with respect to FIG. 2. Referring to FIGS. 1-4, supervisory system 40 instructs controller 30 to track usage of each lamp 68 corresponding to a respective module 20 or module-fixture 22 and individually delays the turn-on for each lamp 68 attached thereto. In the distributed model, controller 30 sends general ON, OFF, or DIM% commands to all modules 20 and module-fixtures 22. Controller 30 may have the capability to individually address and separately control each module 20 and module-fixture 22, but in many applications, such lighting for parking lots, factories, and warehouses, this functionality is not required.

Controller 30 may also maintain a database or list of each module 20 and/or module-fixture 22 with associated hours-of-operation data and turn-on data of connected lamps 68. With regard to the hours-of-operation, information is input into controller 30 when a lamp replacement is made, and the expected hours of operation of the replacement lamp. This input can be done manually by a technician at the time of lamp replacement, or automatically. For example, module-fixture 22 may include a lamp sensor 84 having a plunger-switch to detect the removal of lamp 68.

Other means of detecting the removal of lamp 68 are contemplated, such as an optical sensor or magnetic sensor disposed in the lamp base. Alternatively, control unit 60 of either a module 20 or module-fixture 22 may perform a periodic continuity check on lamp 68. When the continuity is broken, that is an indication that the lamp is either removed or burned-out. This technique has the advantage that it will work with conventional fixtures, e.g., fixture 24. Other types of sensors may be used as well, as would occur to the skilled artisan.

Regardless as to the type of sensor employed, when it detects that lamp 68 is replaced, it sends a signal to control unit 60, which sends a signal to controller 30. Controller 30 identifies the address of the module-fixture 22 that sent the signal, and responds by resetting the hours-of-operation data for that fixture to the selected amount.

Controller 30 automatically and periodically decrements the hours-of-operation remaining for each lamp 68 that that lamp is on. For example, every hour, controller 30 may check which lamps are on, and decrement the hours-of-operation data for those lamps by one. Alternatively, controller 30 may track the minutes or other fractions of an hour, such as tenths of an hour (i.e., six-minute increments), of operation for each lamp, and sum the total as a fraction of hours. When the hours-of-operation data reaches zero for any one module 20 or module-fixture 22, a signal is sent to that module 20 or module-fixture 22 causing it to illuminate its indicator 74, thereby informing maintenance personnel that the connected lamp 68 is due to be replaced.

Similarly, when a lamp 68 fails to generate a load, control unit 60 senses this and sends a signal to controller 30, indicating that the lamp is no longer functioning. Controller 30 then sends a signal back to that module 20 or module-fixture 22, causing it to illuminate its indicator 74. In addition, controller 30 informs the operator that the lamp no longer functions, and may provide a graphic or other indication as to the location of the non-functioning lamp.

To turn on the lamps in lighting control system 10, the operator simply inputs the instruction into controller 30. This input may take the form of flipping a switch from “OFF” to “ON”, or pressing an “ON” button, or interacting with a software program on a computer, in any known manner. For example, a graphical-user interface or other interface can allow the operator to select specific lamps, or every-other lamp, every 10^{th} lamp, or other predetermined groupings of lamps. In some environments, such as a conference center, having individual control over each lamp is very advantageous. In this case, a map of the conference center can be displayed on a computer screen showing the location of each lamp, and each lamp can be individually controlled simply by selecting it and entering a command via a pop-up menu or the like. Individual lamps may be selected by simply clicking the representation on the screen of the lamp, and multiple lamps can be selected by dragging a box around the lamps to be turned on off, or dimmed. These functions can also be performed by remote computer 46.

Upon receiving the operator's input instruction for turning on a large number of lamps, controller 30 delays turning on each selected lamp by the amount recorded in its database. FIG. 5 shows a flow chart describing an exemplary process for delaying the start-up time for each lamp.

After starting at box 102 the controller immediately proceeds to box 104 where the controller 30 waits for an ON command for selected lamps by loop 105. After an ON command is inputted into controller 30, controller 30 proceeds to box 106 where the time counter variable is initialized to zero. Then, at box 108, the controller compares the time counter with the turn-on delay value for each selected light fixture. For those selected light fixtures having a turn-on delay that is equal to the value of the time counter, an “ON” command is transmitted to the corresponding modules 20 and/or module-fixtures 22. Controller 30 then proceeds to box 110 wherein a check is performed as to whether all the selected lamps are turned on. If not, the controller proceeds to box 112 and waits for the next clock tick. Clock ticks can be every 10^{th} of a second or otherwise, depending upon the application. Transmission of “ON” commands in box 108 may be processed in parallel, to ensure that each clock tick is counted. When the next clock tick is received, controller 30 proceeds to box 114 wherein the time counter is incremented by the appropriate amount. Controller 30 thereafter returns to box 108 and continues as before.

If the controller reaches box 110 and all selected lamps have been turned on, the controller exits the turn-on delay loop and proceeds to box 120 where the procedure is ended. The turn-on delay data stored in controller 30 may be manually input into controller 30 or the operator can select the time spread for the lamps and instruct controller 30 to automatically select turn-on delays either sequentially or randomly. Alternatively, the operator can simply input the type of lamps used and allow the controller 30, using stored data, to select optimum start-up timings for the lamps in lighting control system 10. The start-up timings will depend on the warm-up time for the type of lamps installed, and limit the total number of lamps warming up at any one time to a selected number of lamps.

Lighting control system 10 automates and provides better control over the lighting system in buildings. The advantages of lighting control system 10 include being able to have multiple customizable lighting scenarios and the ability to dim selected light fixtures. The lighting scenarios can also be implemented via a computer network, which makes it easy to control each light fixture. Lighting control system 10 can also be changed at any time without reworking the electrical system. Each light fixture is controlled locally so that there is more control over the entire system. In addition, the modules are able to be retrofit to existing lighting systems, thereby decreasing the cost of implementing the system.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A lighting control system comprising:
a first control unit for operating a first light fixture, said first control unit arranged to receive a signal from an input device, said first control unit arranged to control said input device; and
a second control unit for operating a second light fixture, said second control unit in operable communication with said first control unit.

2. The system of claim 1, further comprising a current controller in electrical communication with said first control unit.

3. The system of claim 1, further comprising a current sensor in electrical communication with said first control unit.

4. The system of claim 3, wherein said input device includes an indicator in operable communication with said first control unit, said first control unit causing said indicator to illuminate when said current sensor indicates that current fails to flow.

5. The system of claim 4, wherein said input device includes a timer, said timer arranged for counting hours-of-operation of a lamp, said timer includes means for resetting said timer when said lamp is replaced with a new lamp, said first control unit causes said indicator to illuminate in response to said timer having counted a selected number of said hours-of-operation for indicating that said lamp is due to be replaced.

6. The system of claim 5 wherein said timer is a count-down timer and includes a turn wheel for resetting said hours-of-operation and displaying a remaining number of hours of said hours-of-operation.

7. The system of claim 1, wherein said input device includes a turn-on delay timer.

8. The system of claim 7, wherein said turn-on delay timer includes a predetermined time setting.

9. The system of claim 1, wherein said input device includes a photo-sensor for detecting ambient light conditions.

10. The system of claim 1, wherein said input device includes an infrared transceiver.

11. The system of claim 1, further comprising a controller in electronic communication with said first control unit and said second control unit.

12. The system of claim 1, further comprising a computer network in electronic communication with said controller.

13. The system of claim 1, further comprising a supervisory system controlling said first control unit.

14. A lighting control system comprising:
a plurality of light fixtures;
a plurality of control units; and
wherein a first control unit of said plurality of control units is in electrical communication with a first light fixture of said plurality of light fixtures, said first control unit arranged to receive a signal from an input device, said first control unit arranged to control said input device; and
a second control unit for operating a second light fixture of said plurality of light fixtures, said second control unit in operable communication with said first control unit.

15. The system of claim 14, further comprising a current controller in electrical communication with said first control unit.

16. The system of claim 14, further comprising a current sensor in electrical communication with said first control unit.

17. The system of claim 16, wherein said input device includes an indicator in operable communication with said first control unit, said first control unit causing said indicator to illuminate when said current sensor indicates that current fails to flow.

18. The system of claim 17, wherein said input device includes a timer, said timer arranged for counting hours-of-operation of a lamp, said timer includes means for resetting said timer when said lamp is replaced with a new lamp, said first control unit causes said indicator to illuminate in response to said timer having counted a selected number of said hours-of-operation for indicating that said lamp is due to be replaced.

19. The system of claim 18, wherein said timer is a count-down timer and includes a turn wheel for resetting said hours-of-operation and displaying a remaining number of hours of said hours-of-operation.

20. The system of claim 14, wherein said input device includes a turn-on delay timer.

21. The system of claim 20, wherein said turn-on delay timer includes a predetermined time setting.

22. The system of claim 14, wherein said input device includes a photo-sensor for detecting ambient light conditions.

23. The system of claim 14, wherein said input device includes an infrared transceiver.

24. The system of claim 14, further comprising a controller in electronic communication with said first control unit and said second control unit.

25. The system of claim 14, further comprising a computer network in electronic communication with said controller.

26. The system of claim 14, further comprising a supervisory system controlling said first control unit.

27. A light control system comprising:
a power line;
a first light fixture in electrical communication with said power line;
a first control unit in electrical communication with said power line, said first control unit controls said first light fixture;
a second control unit in electrical communication with said power line, said second control unit controls a second light fixture;
wherein said first control unit communicates with said second control unit through said power line.

28. The system of claim 27, further comprising a circuit breaker in electrical communication with said power line.

29. The system of claim 27, further comprising a controller communicating with said first control unit and said second control unit.

30. The system of claim 27, further comprising a supervisory system controlling said first control unit and said second control unit.

31. The system of claim 27, wherein said power line is in electrical communication with a first branch circuit, said first control unit is disposed on said first branch circuit.

32. The system of claim 31, wherein said branch circuit includes a second branch circuit, said second control unit disposed on said second branch circuit.

33. The system of claim 32, further comprising a first circuit breaker disposed on said first branch circuit and a second circuit breaker disposed on said second branch circuit.
